(19) United States
(12) Patent Application Publication
(10) Pub. No.: US 2024/0076783 A1
(43) Pub. Date: Mar. 7, 2024

(54) Multi-compartment hybrid CO2 electrochemical reducer and hydrogen fuel cell

(71) Applicant: Yonghua Wang, Klamath Falls, OR (US)

(72) Inventor: Yonghua Wang, Klamath Falls, OR (US)

(21) Appl. No.: 17/803,599

(22) Filed: Sep. 2, 2022

(51) Int. Cl. C25B 1/23; C25B 9/21; C25B 13/04; H01M 8/22; H01M 16/00

(52) U.S. Cl. CPC C25B 1/23; C25B 9/21; C25B 13/04; H01M 8/22; H01M 16/003

(57) ABSTRACT

A combined electrochemical CO2 reduction and a fuel cell system cogenerates CO from CO2 and electric power through a hybrid CO2 reducer and a Hydroxide Exchange Membrane Fuel Cell (HEMFC) system driven by hydrogen and oxygen generated from renewable energy. In the structure of the hybrid system, a CO2 cell chamber compartment and a hydrogen cell chamber compartment are incorporated into a HEMFC, wherein CO2 is reduced into CO by protons generated in the electric power generation process of fuel cell.

### TECHNICAL FIELD

The present disclosure relates generally to a hybrid CO2 electrochemical reducer and hydrogen fuel cell, more specifically, to multi-compartment hybrid CO2 electrochemical reducer and hydrogen fuel cell.

### BACKGROUND

Carbon based fossil fuels are approved to be the best mediums of solar energy storage, however it takes millions of years to turn the solar energy accumulated into plants and animals into fossil fuels and the modern usage of fossil fuel emits the green house gas carbon dioxide. Therefore, the modern society is facing to the grant challenges of fossil fuel depletion and global warming. In order to address the energy crisis and curb the climate change, the entire world scrambles in searching solution to address the issues caused by fossil fuel consumption and carbon dioxide (CO2) emission. One of the most desirable approaches in addressing CO2 is turning it into liquid fuel by using renewable energy. One of the pathways in transition of CO2 into liquid fuel methanol includes two steps: 1) electrochemically reduce CO2 into CO by deploying electric power generated by solar energy; 2) synthesize CO and hydrogen generated through electrolysis of water using solar generated electric power into liquid methanol.

U.S. Pat. No. 8,138,380 B2 granted to Olah et al discloses an apparatus converting carbon dioxide by an electrochemical reduction of carbon dioxide in a divided electrochemical cell that includes an anode in one compartment and a metal cathode electrode in a compartment that also contains an aqueous solution comprising methanol and an electrolyte. An anion-conducting membrane can be provided between the anode and cathode to produce at the cathode therein a reaction mixture containing carbon monoxide and hydrogen, which can be subsequently used to produce methanol while also producing oxygen in the cell at the anode.

EP. Pat. No. 3358042 B1 granted to Kudo et al discloses an electrolysis cell and electrolytic device for carbon dioxide providing an electrolysis cell and electrolytic device for carbon dioxide which make it possible to suppress a variation in a cell voltage in an electrolytic reaction of carbon dioxide.

In prior arts, CO2 is reduced into CO either through electrochemical electrolysis of CO2 or CO2 and hydrogen reaction under high pressure and high temperature. The present invention discloses a multi-compartment apparatus that reduce CO2 into CO through fuel cell driven by hydrogen generated from solar power or other renewable energy sources. This apparatus generates electric power while reduce CO2 into CO. The entire apparatus is configured with 3 compartments divided by 2 Hydroxide Exchange Membranes (HEM). At one end of the apparatus, CO2 and hydrogen are fed in together, wherein the hydrogen loss electron become proton and reduce CO2 into CO. At other end of the apparatus, oxygen is fed in to form an alkaline fuel cell loop to generate electricity.

In conventional approach to liquid fuel from CO2, renewable energy generated electric power is employed to reduce CO2 into CO and split H2O into hydrogen and oxygen, then the CO and hydrogen are synthesized into methanol. In the disclosure of the present invention, the solar power generated hydrogen and oxygen are employed to drive fuel cell to generate electric power and simultaneously reduce CO2 into CO, then the CO and hydrogen are synthesized into methanol.

The characteristics of the present invention will become more apparent as the present description proceeds.

### Objects

The objects of this invention are to: (1) provide a design paradigm for multi-compartment cell that can generate electric power by consuming hydrogen and oxygen; (2) provide a mechanism that can be incorporated into fuel cell to reduce CO2 into CO.

### SUMMARY

In the prior arts, CO2 is reduced by electrons provided by external circuit and power sources in an electrolysis cell normally with liquid electrolyte. The limited solubility of CO2 in liquid electrolyte detriments the performance of the electrolysis system on reducing CO2. The present invention discloses an apparatus that employs the protons generated on the anode of the fuel cell to reduce CO2 into CO. In this disclosure, the hydrogen and oxygen generated from water electrolysis system powered by renewable energies are all used to drive fuel cell to generate electric power and simultaneously reduce CO2 into CO.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is the schematic diagram of the hydrogen and oxygen driven electrochemical CO2 reduction and electric power generation system.

### DETAILED DESCRIPTION

Reference will now be made in detail to the present exemplary embodiments, examples of which are illustrated in the accompanying drawings.

Wherever possible, the same reference numbers will be used throughout the drawings to refer to the same or like parts.

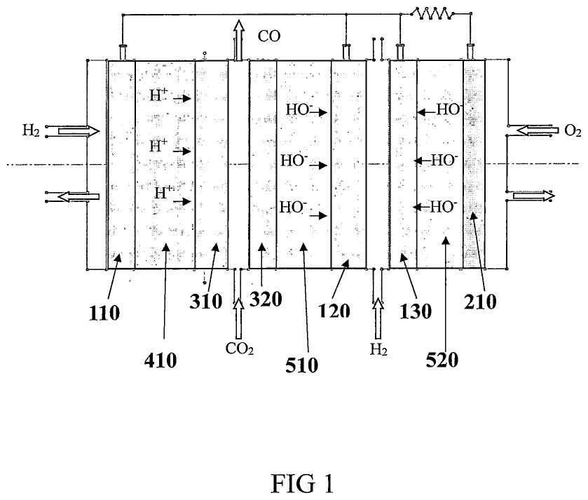

Referring to FIG. 1, the multi-compartment hybrid CO2 electrochemical reducer and hydrogen fuel cell comprises: 1) an anode cell chamber compartment 110; 2) a proton exchange membrane 410; 3) a CO2 electrode cell chamber compartment including 2 electrodes 310, 320; 4) a hydroxyl exchange membrane 510; 5) a hydrogen electrode cell chamber compartment including 2 electrodes 120, 130; 6) another hydroxide exchange membrane 520; 7) a cathode cell chamber compartment 210. Wherein, the components 110, 410, 310, 320, 510, 120, 130, 520, 210 of the system are connected in series; the electrodes 110, 120, 130 are connected in parallel as an anode and connected to the cathode 210 through the external circuit.

Wherein, the following chemical reaction happens on the anode 110:
H=H⁺+e⁻; the following chemical reaction happens on the electrodes 310 and 320:
H⁺+CO₂═CO+HO⁻; the following chemical reaction happens on electrode 120 and 130:
HO⁻+H⁺═H₂O; H=H⁺+e⁻; the following chemical reaction happens on electrode 210:

2H₂O+O₂+4e⁻=4HO⁻.

Wherein, the protons generated on the anode 110 penetrate through the proton exchange membrane 410 arriving electrodes 310 and 320; the hydroxyls generated on electrodes 320 and 210 penetrate the hydroxyl exchange membrane 510 arriving electrode 210.

From the description above, number of advantages of the multi-compartment hybrid CO2 electrochemical reducer and hydrogen fuel cell system become evident: 1) protons are readily available to reduce CO2 into CO; 2) the system generates electric power simultaneously; 3) all products of water electrolysis can be used for this process.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. The multi-compartment hybrid CO2 electrochemical reducer and hydrogen fuel cell comprises: 1) an anode cell chamber compartment; 2) a proton exchange membrane; 3) a CO2 electrode cell chamber compartment including 2 electrodes; 4) a hydroxide exchange membrane; 5) a hydrogen electrode cell chamber compartment including 2 electrodes; 6) another hydroxide exchange membrane; 7) a cathode cell chamber compartment.
Wherein, the components of anode cell chamber compartment, the proton exchange membrane, the CO2 electrode cell chamber compartment including 2 electrodes, the hydroxyl exchange membrane, the hydrogen electrode cell chamber compartment including 2 electrodes, the another hydroxide exchange membrane, the cathode cell chamber compartment of the system are connected in series; the anode cell chamber compartment electrode, hydrogen electrode cell chamber compartment including 2 electrodes, are connected in parallel as an anode and connected to the cathode through the external circuit.
Wherein, the following chemical reaction happens on the anode:
H=H⁺+e⁻; the following chemical reaction happens on the electrodes and:
H⁺+CO₂═CO+HO⁻; the following chemical reaction happens on electrode and:
HO⁻+H⁺═H₂O; H=H⁺+e⁻; the following chemical reaction happens on electrode:
2H₂O+O₂+4e⁻=4HO⁻.
Wherein, the protons generated on the anode penetrate through the proton exchange membrane arriving electrodes and; the hydroxide generated on electrodes and penetrate the hydroxide exchange membrane arriving electrode.
